(19) United States
(12) Patent Application Publication
(10) Pub. No.: US 2008/0267433 A1
(43) Pub. Date: Oct. 30, 2008

(54) Bone-Conduction Loudspeaker Set, Electronic Equipment, Electronic Translation System, Auditory Support System, Navigation Apparatus, and Cellular Phone

(76) Inventors: Tooru Katou, Akita (JP); Masakazu Masaki, Akita (JP); Takashi Tomatsu, Akila (JP)

Correspondence Address: NIXON & VANDERHYE, PC, 901 NORTH GLEBE ROAD, 11TH FLOOR, ARLINGTON, VA, 22203, US

(21) Appl. No.: 11/883,161

(22) PCT Filed: Jan. 31, 2006
(86) PCT No.: PCT/JP2006/301515

§ 371 Date: Mar. 10, 2008

(30) Foreign Application Priority Data
Jan. 31, 2005 (JP) 2005-024311

(51) Int. Cl. H04R 5/02

(52) U.S. Cl. 381/309

(57) ABSTRACT

A bone-conduction loudspeaker set is provided which is similar to the form of a personal ornament. Systems suitable for this are also provided. The bone-conduction loudspeaker set includes: two bone-conduction loudspeaker units; and a loudspeaker-microphone switching unit which switches from a mode where the two bone-conduction loudspeaker units are used as right and left stereo loudspeakers to a mode where one of them is used as a loudspeaker and the other is used as a microphone, and vice versa. A system includes: a mutual-distance detection unit which detects the distance between the two bone-conduction loudspeaker units being within a predetermined distance; and a distress-signal issuance unit which issues a distress signal based on a detection result obtained by the mutual-distance detecting unit.

### BACKGROUND OF THE INVENTION

1. Field of the Invention

The present invention relates to a bone-conduction loudspeaker set which is capable of transmitting a sound signal to the cranium and transferring it to the auditory nerve. It also relates to electronic equipment, an electronic translation system, an auditory support system, a navigation apparatus and a cellular phone which are provided with the bone-conduction loudspeaker.

2. Description of the Background Art

The inventors of this application offer a bone-conduction loudspeaker unit having a similar form to a personal ornament, and a communication system suitable for this unit (refer to Patent Document 1). It includes: an earlobe attachment portion which is attached to an earlobe of a wearer; a pressure-attachment spring portion which curves and extends from the earlobe attachment portion; and a vibration portion which spreads like substantially an inverse triangle along the pressure-attachment spring portion. When it is attached to the human body, using the earlobe attachment portion, the bone-conduction loudspeaker unit is attached to the wearer's earlobe. Then, the vibration portion is pressed and attached to the wearer's mastoid region, and a vibration for transmitting a sound signal is transferred to the mastoid region. The earlobe attachment portion is provided with an ornament attachment structure for attaching an ornament such as a jewel. The pressure-attachment spring portion is made of a shape memorizing alloy. The earlobe attachment portion has a clip structure for clipping the wearer's earlobe from its front and back. Using the communication system, it is used as an earphone for a mobile phone.

In the year 2004, the Japan Society of Mechanical Engineers put forward a bone-conduction loudspeaker using a piezoelectric vibrator (refer to Non-patent Document 1). According to this paper, the human body's auricular cartilage is suitable as the region to which such a bone-conduction loudspeaker using a piezoelectric vibrator should be attached.

Herein, Patent Document 1 is Japanese Patent Laid-Open No. 2004-64457 specification, and Non-patent Document 1 is “Development of a bone-conduction loudspeaker using a piezoelectric vibrator”, 2004.9.27 to 30, Tokyo 307, No. 04-5 Dynamics and Design Conference 2004 CD-ROM Papers, the Japan Society of Mechanical Engineers.

### SUMMARY OF THE INVENTION

The above described disadvantages given by Japanese Patent Laid-Open No. 2004-64457 specification are further expanded. Hence, it is an object of the present invention to provide a further-improved bone-conduction loudspeaker unit which can be not only worn as a personal adornment (e.g., a clip earring and a pierced earring) in daily life by a person who has a hearing disorder as well as a person who has no such disorder, but also used widely as an auditory support system such as an audio system and a translation system, and a system provided with this bone-conduction loudspeaker unit.

In order to resolve the above described disadvantages, a bone-conduction loudspeaker set according to an aspect of the present invention, comprising: two bone-conduction loudspeaker units; and a loudspeaker-microphone switching means which switches from a mode where the two bone-conduction loudspeaker units are used as right and left stereo loudspeakers to a mode where one of the two bone-conduction loudspeaker units is used as a loudspeaker and the other is used as a microphone, and vice versa.

Electronic equipment according to another aspect of the present invention, which is connected by wire or by radio to two bone-conduction loudspeaker units, comprising a loudspeaker-microphone switching means which: allows both of the two bone-conduction loudspeaker units to function as loudspeakers in a contents appreciation mode where a wearer of the bone-conduction loudspeaker units uses contents such as music by means of this electronic equipment; and allows one of the two bone-conduction loudspeaker units to function as a microphone in a voice input mode.

An electronic translation system according to still another aspect of the present invention, which is connected by wire or by radio to two bone-conduction loudspeaker units, comprising a loudspeaker-microphone switching means which: allows both of the two bone-conduction loudspeaker units to function as loudspeakers in a contents regeneration mode where a wearer of the bone-conduction loudspeaker units uses contents such as music by means of this electronic translation system; and allows one of the two bone-conduction loudspeaker units to function as a microphone in a voice input mode where a voice given by an operator needs to be inputted.

An auditory support system according to still another aspect of the present invention, which is connected by wire or by radio to two bone-conduction loudspeaker units, comprising a loudspeaker-microphone switching means which: allows both of the two bone-conduction loudspeaker units to function as loudspeakers in a contents appreciation mode where a wearer of the bone-conduction loudspeaker units uses contents such as music by means of this auditory support system; and allows one of the two bone-conduction loudspeaker units to function as a microphone in a voice input mode where a voice given by an operator needs to be inputted.

A navigation apparatus according to still another aspect of the present invention, which is connected by wire or by radio to two bone-conduction loudspeaker units, comprising: a loudspeaker-position detecting means which detects the positional relation between the two bone-conduction loudspeaker units; and a map turning means which, based on a detection result obtained by the loudspeaker-position detecting means, changes the direction where a map is displayed.

A cellular phone according to still another aspect of the present invention, which is connected by radio to two bone-conduction loudspeaker units, comprising: a mutual-distance detecting means which detects the distance between the two bone-conduction loudspeaker units being within a predetermined distance; and a distress-signal issuing means which issues a distress signal based on a detection result obtained by the mutual-distance detecting means.

The bone-conduction loudspeaker units according to the present invention which have such a configuration as described above are close to a personal ornament. Furthermore, using a communication system, a tool can be provided which enables a hands-free as an earphone and a microphone for the cellular phone. Moreover, a bone-conduction loudspeaker presents an advantage in that the air pathway of an ear can be prevented from blocking up.

Furthermore, according to the above described configuration of the present invention, when appreciating music or the like, a user listens to it using the two loudspeakers. On the other hand, if a voice given by the user is needed, one of the two loudspeakers can be turned to use as a microphone. Moreover, communication is conducted with the loudspeakers attached to both ears, so that the direction where a user is facing can be distinguished. On the basis of such information, navigation can be executed. In addition, communication is normally conducted with the two loudspeakers located within a predetermined interval. Using this feature, if they separate beyond the predetermined interval, a distress signal can be issued.

### BRIEF DESCRIPTION OF THE DRAWINGS

FIG. 1 is a perspective view of right and left bone-conduction loudspeaker units, a microphone unit, a communication system as an adapter and a cellular phone, showing an example of their combination.

FIG. 2 is a conceptual illustration, showing a practical example of the bone-conduction loudspeaker unit.

FIG. 3 is a perspective view of the microphone unit, showing an example of its external appearance.

FIG. 4 is a diagram, showing the internal blocks of the cellular phone, the adapter, the microphone unit and the bone-conduction loudspeaker units.

FIG. 5 is a perspective view of the right and left bone-conduction loudspeaker units and a connection member around the occipital region of a person, showing a practical example of the connection of those units by the connection member.

FIG. 6 is a conceptual illustration, showing the attachment of the right and left bone-conduction loudspeaker units connected by the connection member around the occipital region to the human body.

FIG. 7 is a diagram, showing a communication sequence between the adapter and the bone-conduction loudspeaker units and a communication sequence between the adapter and the microphone unit.

FIG. 8 is a perspective view of a bone-conduction loudspeaker unit according to the present invention, seen from the rear of a wearer when it is attached to the wearer's body.

FIG. 9 is a sectional view of a vibration portion 33, showing its internal structure.

FIG. 10 is a conceptual illustration, showing the configuration of the adapter connected to an earphone-microphone terminal of the cellular phone.

FIG. 11 is a schematic perspective view of a bone-conduction loudspeaker microphone combined with a clip-type ear ornament which is formed by a piezoelectric bone-conduction loudspeaker.

FIG. 12 is a side view of the bone-conduction loudspeaker microphone combined with a clip-type ear ornament.

FIG. 13 is a side view of a bone-conduction loudspeaker microphone combined with a clip-type ear ornament, showing an example where an ornament portion hangs from it.

FIG. 14 is a side view of a bone-conduction loudspeaker microphone used as an ornament for a pierced ear, showing an example where a battery, a substrate and a loudspeaker body are provided on the backside of the auricle.

FIG. 15 is a side view of a bone-conduction loudspeaker microphone used as an ornament for a pierced ear, showing an example where a battery is provided on the face of the auricle while a substrate and a loudspeaker body are provided on its backside.

FIG. 16 is a side view of a bone-conduction loudspeaker microphone used as an ornament for a pierced ear, showing an example where a battery hangs from it while a substrate and a loudspeaker body are provided on the backside of the auricle.

FIG. 17 is a block diagram, showing the hardware configuration of a loudspeaker-microphone switching means.

FIG. 18 is a diagram, showing the mode switching of the loudspeaker-microphone switching means.

FIG. 19 is a flow chart, showing the operation of a control circuit 1008 which forms the loudspeaker-microphone switching means.

### DESCRIPTION OF THE PREFERRED EMBODIMENTS

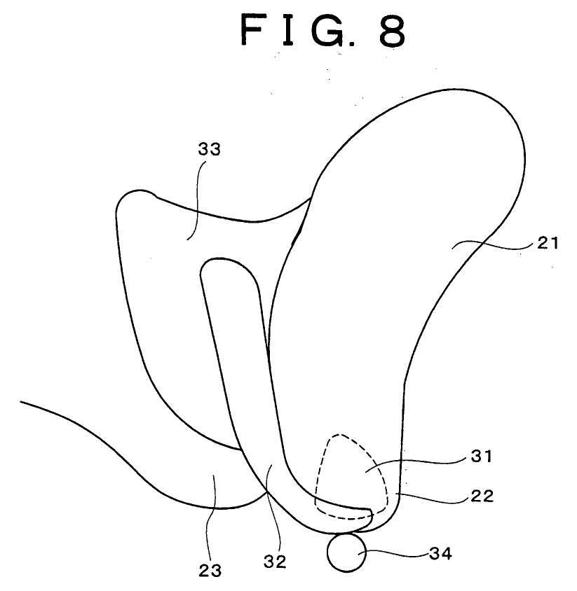

Hereinafter, a bone-conduction loudspeaker unit according to an embodiment of the present invention will be described with reference to the attached drawings. FIG. 8 is a perspective view of a bone-conduction loudspeaker unit according to the present invention, seen from the rear of a wearer when it is attached to the wearer's body. In this figure, an auricle 21, an earlobe 22 and a mastoid region 23 are each a region of the body of a person who wears this bone-conduction loudspeaker unit. The auricle 21 is a region of a so-called external ear and is an organ which protrudes right and left from the head. The earlobe 22 is a region which is the lowermost part of the auricle and is soft with no cartilage. It is the earlobe that a clip earring or a pierced earring is put on. The mastoid region 23 is a region which lies on the backside of the auricle and is stiff and slightly protruding.

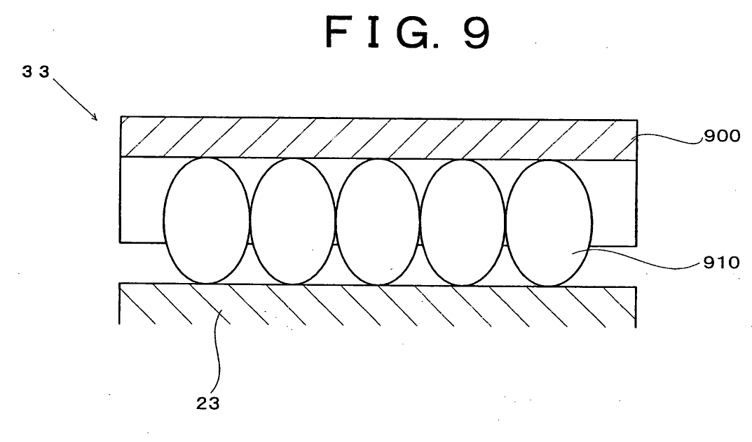

The shape of a vibration portion 33 will be described with reference to FIG. 8 and FIG. 9. FIG. 9 is a sectional view of the vibration portion 33, showing its internal structure. The vibration portion 33 is formed by wrapping a diaphragm 900 in an elastic soft silicone and is shaped like an inverse triangle whose gently-curved base is located above. It front part curves forward in the direction of the external auditory canal from its auricle adhesion portion. Then, it has an outward convex shape along the shape of the mastoid region 23 and reaches the hairline of the head. The material of the part which touches the skin is a soft silicone. Thereby, even if it shifts a little, this part is pressed and attached over its considerable area to the mastoid region 23. Inside of the vibration portion 33, as shown in FIG. 9, conductive spheres 910 which are each a ball-shaped vibration transfer medium (e.g., a hard metal) are provided between the diaphragm 900 and the mastoid region 23. Hence, even if it is displaced and kept out of contact, an effective vibration can be transmitted, as long as a part of it is in contact.

Next, a pressure-attachment spring portion 32 will be described with reference to FIG. 8. The pressure-attachment spring portion 32 is a member which is provided so as to run vertically along the vibration portion 33. The vibration portion 33 is pressed and attached in the direction of the mastoid region 23 by this pressure-attachment spring portion 32. Most of the upper part of the pressure-attachment spring portion 32 is shaped like a flat plate, so that it adheres over its entire area to the vibration portion 33. On its lower side, the pressure-attachment spring portion 32 is shaped like a pipe, so that an electric circuit can be housed in its hollow part. The pressure-attachment spring portion 32 is made of, for example, a shape memorizing alloy or a special resin. It is adjusted according to the temperature of a human body around the backside of the auricle 21 so that a pressure-attachment effect can be obtained.

The lower part of the pressure-attachment spring portion 32 bends by an angle of 30 degrees in the direction of the earlobe 22. From its lowest part, it turns around and goes up ahead so as to cover the earlobe 22 and reaches in front of the earlobe 22. In other words, it is shaped like a clip which holds the earlobe 22 between. The lowest part has a structure (e.g., a hole, a ring and a hook) for attaching an ornament. An earlobe attachment portion 31 which is a turn-up part in front of the earlobe 22 has a highly-ornamental element shape in itself. Hence, its surface can be dressed so as to have a highly-ornamental element.

A bone-conduction loudspeaker unit 30 is configured by these earlobe attachment portion 31, pressure-attachment spring portion 32, vibration portion 33 and ornament attachment portion 34. Desirably, it should be worn on both right and left ears. Besides, it is difficult to feel the difference between the right and the left, but their vibrations are given a right and left difference according to the right and left difference in a field of sound. Thereby, a sense of direction can be obtained as a bodily sensation.

In this bone-conduction loudspeaker unit 30, if a microphone is simply attached at a proper place, for example, near the earlobe attachment portion 31, then it can be used as a hearing aid. The earlobe attachment portion 31 is fixed by sandwiching the earlobe 22 between the above described clip. However, it may also be fixed to the earlobe 22 by a screwed-type method or driving a screw in tightly.

Unless a source for a sound signal is provided in the bone-conduction loudspeaker unit 30, circuits (e.g., a communication control circuit, a reception circuit, a transmission circuit and an antenna) necessary for radio communication are supposed to be internally provided. These can be disposed inside of the above described pressure-attachment spring portion 32. Besides, the pressure-attachment spring portion 32 itself can also work as an antenna. As the radio communication, communication can be conducted not only by a radio wave, but also by an ultrasonic wave. In this communication, all it needs is short-distance communication, for example, communication with equipment carried in a pocket of a suit of clothes.

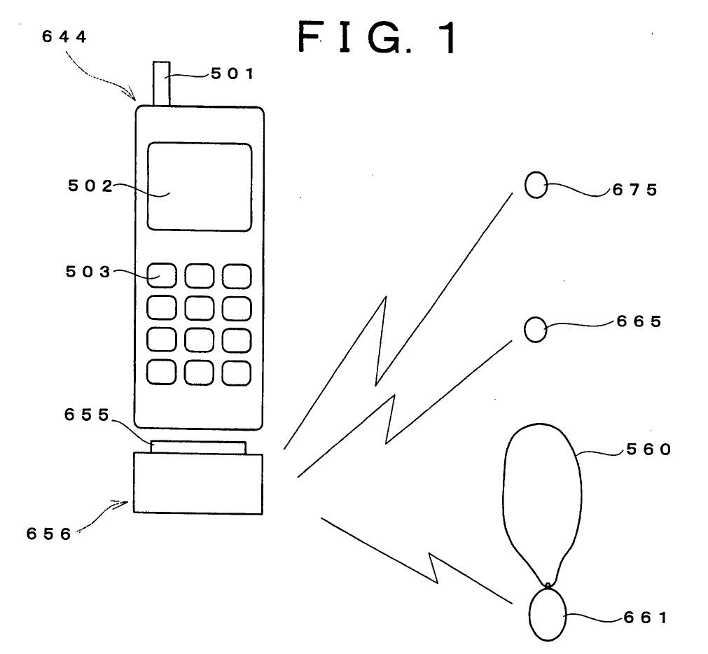

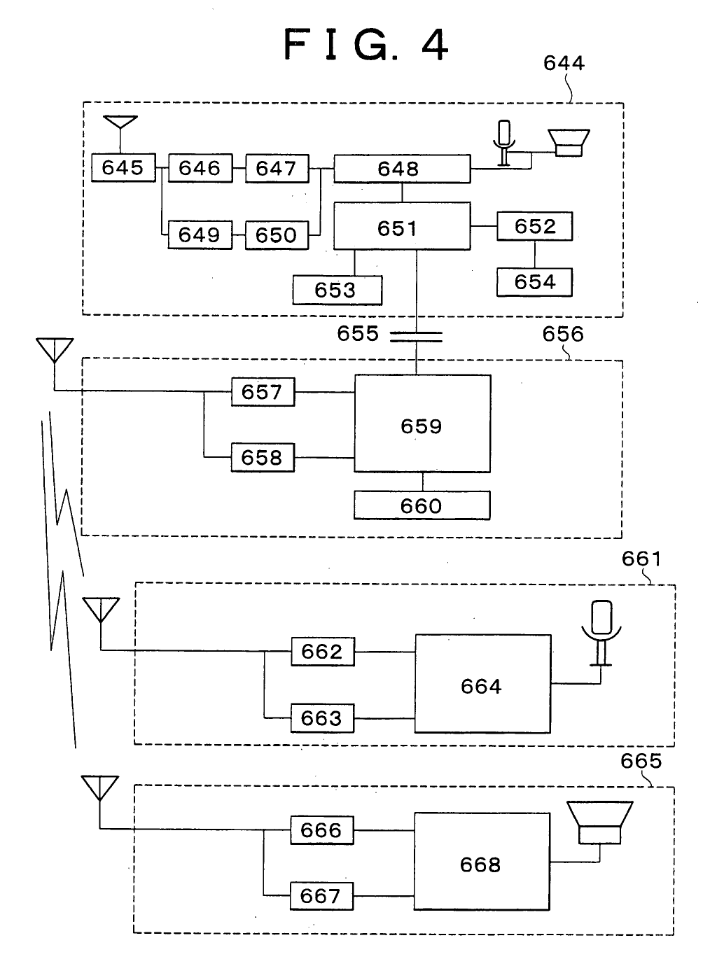

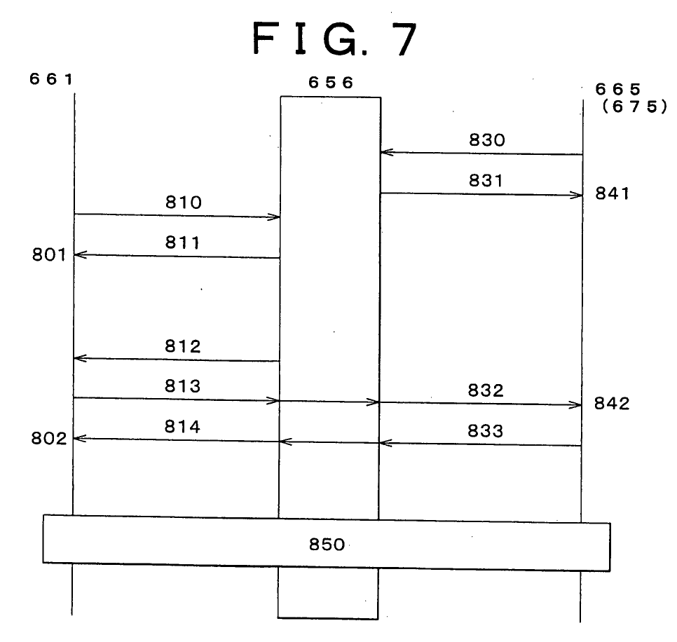

FIG. 1 is a perspective view of right and left bone-conduction loudspeaker units, a microphone unit, a communication system as an adapter and a cellular phone, showing an example of their combination. An adapter 656 is connected via an I/O terminal 655 to a cellular phone 644. The I/O terminal 655 includes several terminals which are connected to connectors of the cellular phone 644. The cellular phone 644 includes, as widely known, an antenna 501, a display portion 502, a dial button 503, and the like. The adapter 656 conducts radio communication with the right and left bone-conduction loudspeaker units 665, 675. In the same way, the adapter 656 conducts radio communication with a microphone unit 661. FIG. 4 is a diagram, showing the internal block of each such unit (in FIG. 4, the internal block diagram of the bone-conduction loudspeaker unit 675 is omitted, but it is the same as the bone-conduction loudspeaker unit 665). Then, FIG. 7 shows their communication sequences.

As shown in FIG. 4, equipment has communication control circuits 651, 659, 664, 668, transmission circuits 649, 658, 663, 667 and reception circuits 646, 657, 662, 666, respectively. In addition, the cellular phone 644 includes: an RF circuit 645 which is linked to the antenna 501; a modulation circuit 647 which modulates the output of the reception circuit 646; a base-band portion 648 which sends an output signal of the modulation circuit 647 to an earphone or a microphone; the communication control circuit 651 which is linked to the base-band portion 648; a memory 653 which is linked to this; a display control portion 652; an LCD 654; and a demodulation circuit 650 which receives, via the base-band portion 648, an output toward a central telephone exchange from the communication control circuit 651 and sends it to the transmission circuit 649. Furthermore, the adapter 656 connected via the connectors 655 to the cellular phone 644 is provided with a database 660 which is necessary for inputting or outputting, by the microphone unit 661 and the bone-conduction loudspeaker unit 665, a voice to be naturally inputted or outputted by an earphone or a microphone inside of the cellular phone 644. The adapter 656, the microphone unit 661 and the bone-conduction loudspeaker unit 665 are each provided with an antenna, so that they can conduct radio communication.

Through such sequences as shown in FIG. 7, procedures are conducted for a connection request, a connection verification and a training. After it is completed, voice-and-data communication 850 is designed to start. The bone-conduction loudspeaker unit 665 (675) sends a connection-request transmission 830 to the adapter 656. In response to this, it receives a connection-verification signal reception 831 and thus comes into an idle state 841. The microphone unit 661 sends a connection-request transmission 810 to the adapter 656. In response to this, it receives a connection-verification signal reception 811 and thus comes into an idle state 801. Then, the microphone unit 661 receives a training-data transmission-request reception 812 from the adapter 656. In response to this, it sends a training-data transmission 813 to the adapter 656, and then, the adapter 656 sends it to the bone-conduction loudspeaker unit 665 (675). Upon receiving a training-data reception 832, the bone-conduction loudspeaker unit 665 (675) comes into a ready state 842. In response to this, it sends a training-data transmission 833, and the adapter 656 sends it to the microphone unit 661. Upon receiving a training-data reception 814, the microphone unit 661 comes into a ready state 802. Through these procedures, the voice-and-data communication 850 can be implemented between the microphone unit 661, the adapter 656 and the bone-conduction loudspeaker unit 665 (675).

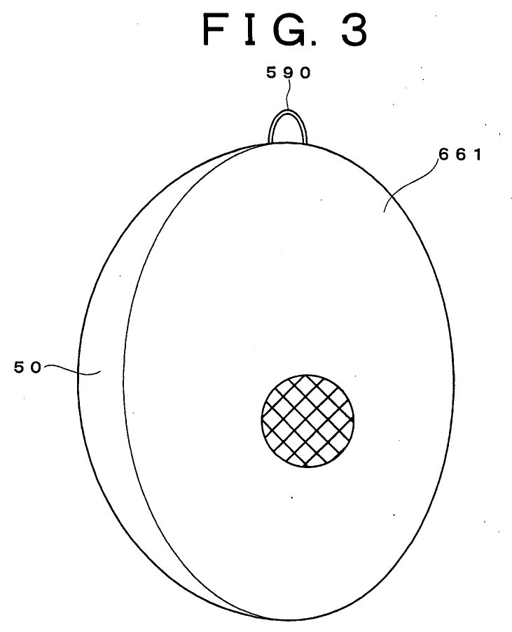

FIG. 3 is a perspective view of a microphone unit 661, showing an example of its external appearance. It has the same configuration as a so-called wireless microphone and looks like an ornamental article such as a so-called brooch. An ornament portion 50 includes an attachment portion 590 for passing a chain, a string or the like.

### Practical Example 1

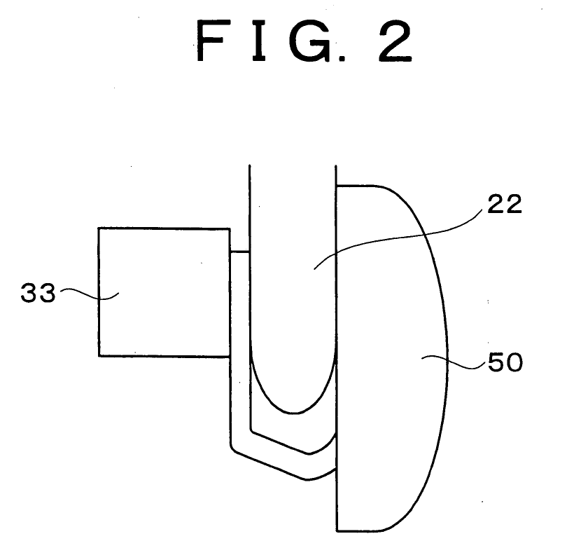

FIG. 2 is a conceptual illustration, showing a practical example of the bone-conduction loudspeaker unit 665 (675). In this example, it is configured as an apparatus which is clipped onto the earlobe 22. The vibration portion 33 is disposed close to the earlobe 22. In the case where a vibration can be transmitted to the region of a human body near the backside of the earlobe 22, this practical example is possible. The ornament portion 50 is disposed so as to cover the clip.

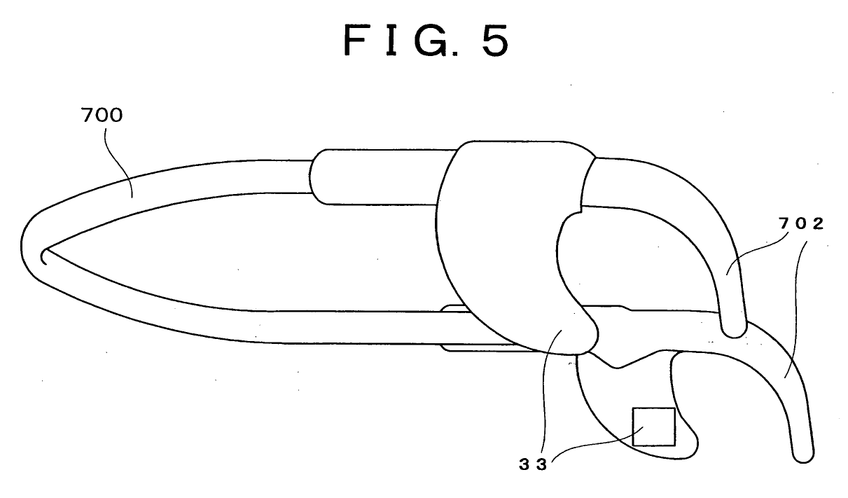

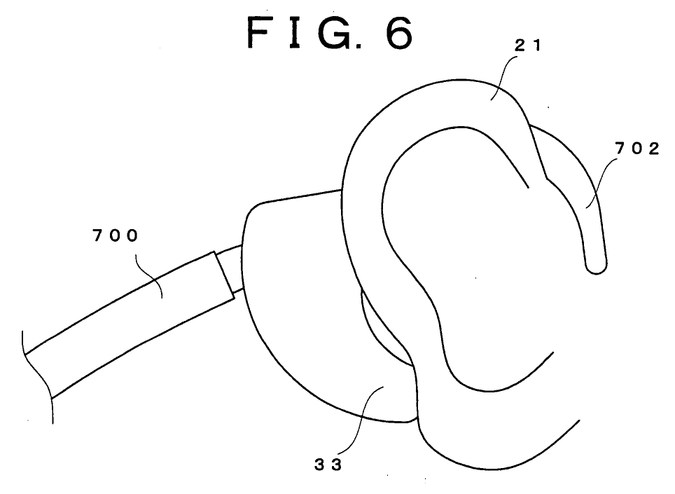

FIG. 5 and FIG. 6 are each a perspective view of the right and left bone-conduction loudspeaker units and a connection member around the occipital region of a person, showing an example of the connection of those units by the connection member. If a person does not mind wearing such a connection member around the occipital region, an advantage can be obtained in that the vibration portion 33 adheres closely to the mastoid region so that the person can secure a feeling of tight contact. Besides, a part of a necessary circuit can be inserted into a connection member 700. In the figure, it is hung and fixed on the auricles by means of a pair of hooks 702.

The above described communication system is described on the assumption that it is connected to a cellular phone. However, a practical example where this adapter is used for a radio, a CD player, an MD player, a DVD player, a television or the like, another practical example where it is used as a hearing aid by connecting the adapter to a microphone unit, and the like, are also within the scope of the present invention.

Incidentally, if this pair of bone-conduction loudspeaker units is used as a communication tool among those who work underwater, preferably, communication should be conducted by an ultrasonic wave, not a radio wave.

### Practical Example 2

In Practical Example 1 described above, the two bone-conduction loudspeaker units are used as loudspeakers. Except for this, another microphone is further used so that a microphone and a loudspeaker can be realized. However, there is a practical example which is more convenient than the case where a microphone is provided in a pendant. This is to use one of the two loudspeakers as a microphone, too. Practical Example 2 is based upon the fact that the inventors of this application have performed experiments diligently and found out that a bone-conduction loudspeaker can be used contrarily as a microphone. Specifically, a bone-conduction loudspeaker set can be realized which includes: two bone-conduction loudspeaker units; and a loudspeaker-microphone switching means which switches from a mode where these bone-conduction loudspeaker units are used as right and left stereo loudspeakers to a mode where one of them is used as a loudspeaker and the other is used as a microphone, and vice versa. Therefore, in the mode where the two loudspeakers are both used as loudspeakers, a stereophonic sound is realized. On the other hand, in the mode where one is used as a microphone, a monaural sound is realized. If some alterations are made to the hardware configuration shown in FIG. 4 and the sequence diagram shown in FIG. 7d, such a loudspeaker-microphone switching means can be realized. Specifically, one of the two bone-conduction loudspeaker units is provided with a software-like switch which makes a changeover using an electric signal. Thereby, switching is conducted to a circuit necessary when it is used as a microphone. Then, in each of a usage mode as a microphone and a usage mode as a loudspeaker, a sequence similar to that of FIG. 7 is provided, so that communication can be realized.

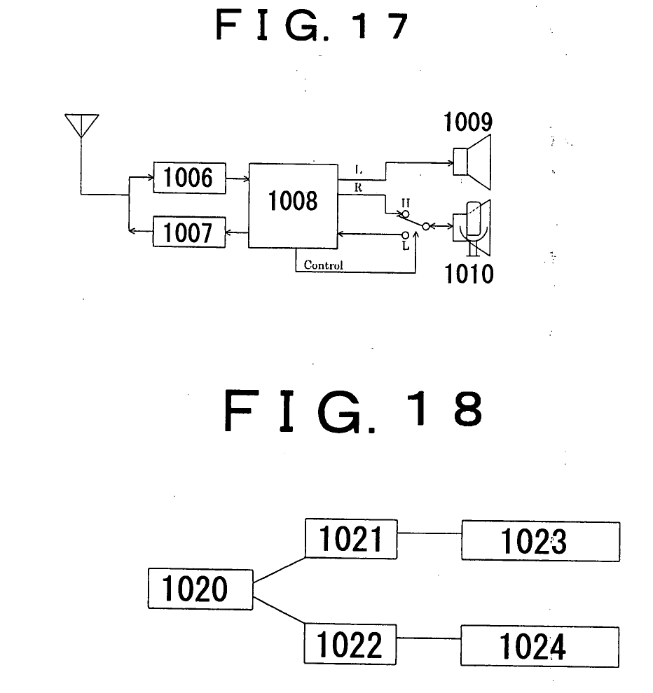

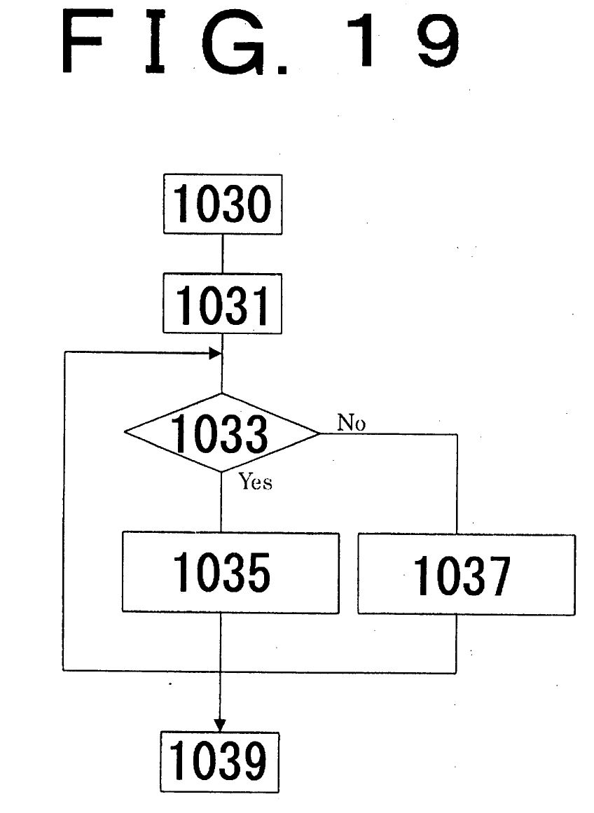

Using FIG. 17, FIG. 18 and FIG. 19, a detailed example will be described in which a loudspeaker-microphone switching means is implemented. FIG. 17 is a block diagram, showing the hardware configuration of the loudspeaker-microphone switching means. A control circuit 1008 is a control circuit which links and works with a reception circuit 1006 and a transmission circuit 1007. It can control the operation of a loudspeaker-microphone combination 1010, specifically, whether it is used as a loudspeaker (i.e., connected to a terminal H), or it is used as a microphone (i.e., connected to a terminal L). In a mode where the loudspeaker-microphone combination 1010 functions as a loudspeaker, a left voice signal is sent to a dedicated loudspeaker 1009 and a right voice signal is sent to the loudspeaker-microphone combination 1010. In a mode where the loudspeaker-microphone combination 1010 functions as a microphone, only a left voice signal (or a synthesis of right and left voice signals) is sent to the dedicated loudspeaker 1009. FIG. 18 is a diagram, showing a mode switching 1020. The mode switching 1020 conducts a switch of a reception state 1021 and a transmission state 1022. In the reception state 1021, a change-over switch is liked to the side of the terminal H of FIG. 17, and thus, the loudspeaker-microphone combination 1010 operates as a loudspeaker (1023). In the transmission state 1022, the change-over switch is liked to the side of the terminal L of FIG. 17, and thus, the loudspeaker-microphone combination 1010 operates as a microphone (1024). FIG. 19 is a flow chart, showing the control circuit 1008 which forms the loudspeaker-microphone switching means. The control circuit 1008 starts to operate (1030) and executes an initialization (1031). The initialization is set to a mode where a microphone-loudspeaker combination operates as a loudspeaker. Next, a decision is made whether or not a transmission circuit is in operation (1033). If a person is just enjoying music, the decision is made that a transmission is not conducted. On the other hand, if the person is making a telephone call or in another such case, the decision is made that a transmission is conducted. If the decision is made that a transmission is conducted, a transmission setting 1035 is executed. Specifically, the microphone-loudspeaker combination is connected to the terminal L, so that the microphone comes into operation. When a transmission is not conducted, the decision is made that a reception (i.e., only a reception) is conducted. Then, a reception setting 1037 is executed. Specifically, the microphone-loudspeaker combination is connected to the terminal H, so that the loudspeaker comes into operation. This operation comes to an end (1039) when the power supply is cut or at another such time.

### Practical Example 3

Practical Example 3 is a practical example in which the bone-conduction loudspeaker units of Practical Example 2 are used as an earphone and a microphone for a cellular phone. Specifically, it is a cellular phone which is connected by wire or by radio to the two bone-conduction loudspeaker units. In a contents appreciation mode where a user of the bone-conduction loudspeaker units uses contents such as music by means of this electronic equipment, these bone-conduction loudspeaker units are both used as loudspeakers. When a telephone call is given and a changeover is made to a talking mode, one of the two bone-conduction loudspeaker units functions as a microphone. This switching is conducted by a loudspeaker-microphone switching means, and thus, a cellular phone including this switching means is put forward. Thereby, when music contents, voice information contents or the like on the Web site are regenerated using the cellular phone, information can be acquired from both ears. On the other hand, when a telephone call is given and a switchover is made to the talking mode, one bone-conduction loudspeaker is used as a microphone. This makes it possible to talk and listen at the same time. By the way, in talking on the phone, communication is conducted while a speaking signal at the other end is mixing with a speaking signal on this side. Therefore, no problem will arise even if voices get mixed together in the cranium. In the above described loudspeaker-microphone switching means, a changeover can be automatically made based on a reception signal of a cellular phone. Furthermore, the two bone-conduction loudspeakers are placed on both sides of the face of a person who wears them, so that the direction where this person's face is looking can be detected. Accordingly, a navigation function can also be added by communicating with a GPS apparatus. Moreover, it is conceivable that a voiceprint is detected from a voice acquired through the microphone so that a banking system having a greater security function can be offered as a Web service for a cellular phone. Then, a service for linking with information on a transportation route or a map, or the like, can also be considered. In addition, a crime preventive function can be given, such as issuing an SOS signal when the two bone-conduction loudspeakers are abnormally apart from each other. This SOS signal can be sent, by phone or e-mail, using a cellular phone which has a connection at that time. Besides, an alarm sound for simply asking a passerby for help can be given. This alarm sound can be set to a sound for merely notifying a person who carries the bone-conduction loudspeakers that they have dropped.

### Practical Example 4

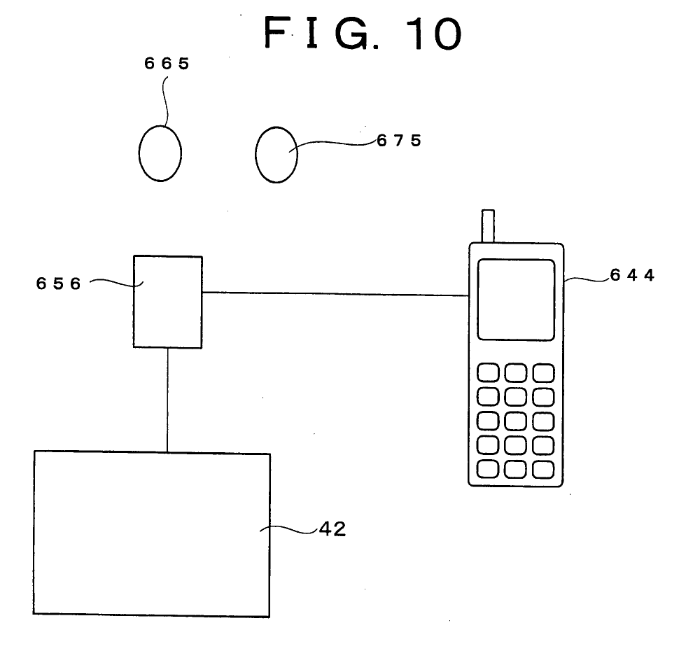

In Practical Example 3, music contents or the like are regenerated using functions of a cellular phone. However, there is a case where a person enjoys music contents using a CD player, an MD player, an MP3 player or the like. In this case, the present invention is applicable to an adapter which is capable of preventing the person from missing a call or a mail received by a cellular phone while listening. This application example corresponds to Practical Example 4. Specifically, it is a cellular-phone adapter connected to an earphone-microphone terminal of a cellular phone. This adapter includes: a sound-source input terminal which accepts an input from another sound-source regenerator; a radio communicating means which communicates by radio with the two bone-conduction loudspeaker units; a sound-source regeneration mode in which a sound source from the sound-source input terminal is enjoyed using these two bone-conduction loudspeaker units as right and left stereo loudspeakers; and a loudspeaker-microphone switching means which, when the cellular phone receives a call or a mail, switches to a talking mode where one of the two bone-conduction loudspeaker units is used as a loudspeaker and the other is used as a microphone. FIG. 10 is a conceptual illustration, showing this practical example. FIG. 10 is a conceptual illustration, showing the configuration of the adapter connected to the earphone-microphone terminal of the cellular phone. In FIG. 10, a CD player 42 can be replaced with the one which a person carries to enjoy music personally, such as an MD player and an MP3 player. An adapter 656 according to the present invention is connected to a headphone terminal of such a music regenerator. The adapter 656 is also connected to a cellular phone 644. Besides, the adapter 656 is designed to be exchangeable by radio with each of bone-conduction loudspeaker units 665, 675. This function is the same as that shown in the ladder diagram of FIG. 7.

### Practical Example 5

A switch of a sound-listening mode and a speaking mode is convenient, but that is not limited to a cellular phone. In the case of a personal computer, similar needs are thinkable. An example in which the present invention is applied to a personal computer corresponds to Practical Example 5. When a user appreciates music, a DVD or the like, it is desirable that the user listen to a stereo regeneration of two loudspeakers. On the other hand, in some cases, a voice of the user needs inputting. For example, a microphone is required when security is strengthened using voiceprint authentication, or when an input in a word processor is conducted using voice recognition. Hence, it is a personal computer which is connected by wire or by radio to the two bone-conduction loudspeaker units. In a contents appreciation mode where a person who wears the bone-conduction loudspeaker units uses contents such as music by means of this personal computer, these bone-conduction loudspeaker units are both used as loudspeakers. In contrast, in a voice input mode where a voice of an operator needs to be inputted, one of the two bone-conduction loudspeaker units functions as a microphone. This is implemented by a loudspeaker-microphone switching means, and thus, the personal computer including this switching means is offered. In the case where a personal computer is used, if a camera is additionally attached, then in addition to a person's voiceprint, the person can be identified by the feature including the position of the eyes and nose, the fingerprint and the like. This helps enhance the security function.

### Practical Example 6

Practical Example 6 is an example in which the present invention is applied to an electronic dictionary. When the spelling of a word is unclear, it is often convenient to retrieve it using its pronunciation. In order to input a pronunciation, a voice input is more convenient than using a pronunciation symbol. Thus, a microphone is necessary. On the other hand, even in the case of an electronic dictionary, if there is no need for a voice input, it is said to be desirable that an output be obtained from two loudspeakers. Thus, it is an electronic dictionary which is connected by wire or by radio to the two bone-conduction loudspeaker units. In a contents appreciation mode where a person who wears the bone-conduction loudspeaker units uses contents such as a pronunciation by means of this electronic dictionary, these bone-conduction loudspeaker units are both used as loudspeakers. In contrast, in a voice input mode where a voice of an operator needs to be inputted, one of the two bone-conduction loudspeaker units functions as a microphone. This is implemented by a loudspeaker-microphone switching means, and thus, the electronic dictionary including this switching means is offered.

### Practical Example 7

Practical Example 7 is an example in which the present invention is applied to an electronic translation system. In the case where persons who each have a different language as the mother tongue need to talk, there are needs of the fact that the persons speak using a single microphone, but want to listen using both ears. Thus, it is an electronic translation system which is connected by wire or by radio to the two bone-conduction loudspeaker units. In a contents regeneration mode where a person who wears the bone-conduction loudspeaker units uses contents such as a voice by means of this electronic translation system, these bone-conduction loudspeaker units are both used as loudspeakers. In contrast, in a voice input mode where a voice of an operator needs to be inputted, one of the two bone-conduction loudspeaker units functions as a microphone. This is implemented by a loudspeaker-microphone switching means, and thus, the electronic translation system including this switching means is offered. In the electronic translation system, a display unit may also be additionally provided. Thereby, a translation result can be displayed as a text, thus helping comprehend a word visually.

### Practical Example 8

Practical Example 7 is an example in which the present invention is applied to an auditory support system which is connected by wire or by radio to the two bone-conduction loudspeaker units. The auditory support system is suggested which includes a loudspeaker-microphone switching means which: allows both of the two bone-conduction loudspeaker units to function as loudspeakers in a contents appreciation mode where a wearer of the bone-conduction loudspeaker units uses contents such as music by means of this auditory support system; and allows one of the two bone-conduction loudspeaker units to function as a microphone in a voice input mode where a voice given by an operator needs to be inputted. In order to help a hearing-impaired person understand, preferably, a visual means should be used. Hence, a person who has difficulty in hearing not only can listen in a loud voice, but also can look at contents text-displayed by a display means. This makes it possible to communicate with a person who does not understand sign language. It is desirable that a voice recognition program be utilized for a text conversion. When the bone-conduction loudspeaker formed by using the above described piezoelectric vibrator is used as a microphone, the correct recognition rate of voice recognition also becomes higher.

### Practical Example 9

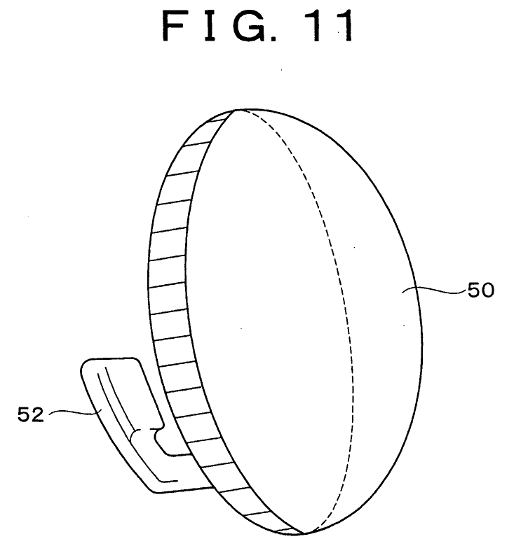

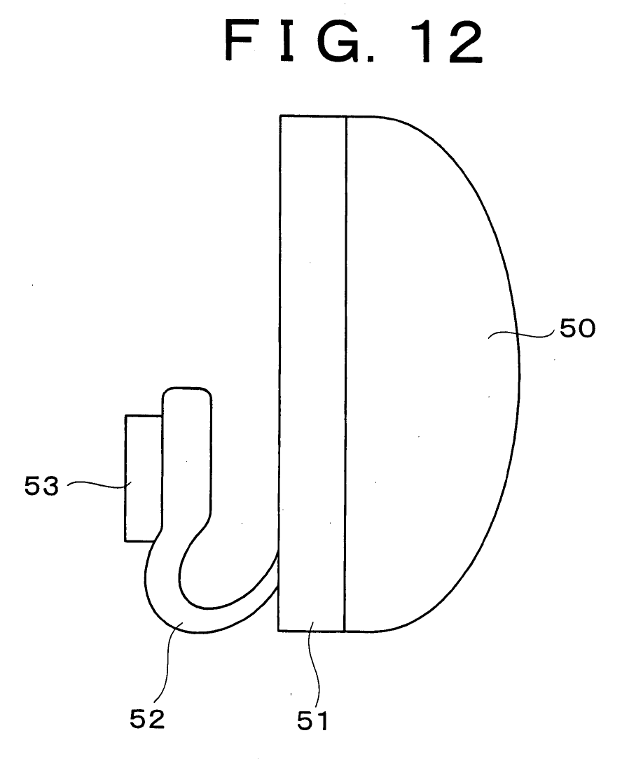

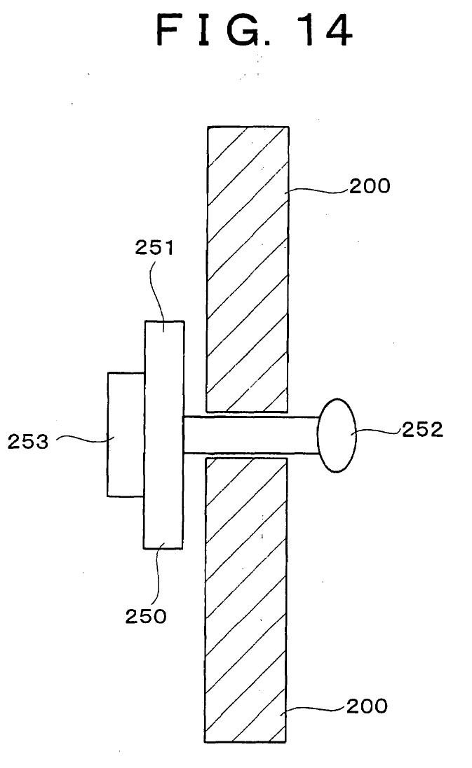

Hereinafter, Practical Example 9 will be described with reference to FIG. 11 and FIG. 12. FIG. 11 is a schematic perspective view of a bone-conduction loudspeaker microphone combined with an ear ornament (e.g., a clip-type ear ornament which holds the auricle between without making a hole piercing the auricle in the human body) which is formed by a piezoelectric bone-conduction loudspeaker. FIG. 12 is a side view of the bone-conduction loudspeaker microphone combined with a clip-type ear ornament. In FIGS. 11, 12 and 13, each ear ornament is an ear-clip type which clips an earlobe (in FIGS. 14, 15 and 16 mentioned later, pierced-type earrings are shown which are each fixed to a hole piercing an earlobe). As an example of the bone-conduction loudspeaker microphone, herein, a piezoelectric-element-type bone-conduction loudspeaker microphone is proposed. The piezoelectric type is lighter and smaller than a magnetic type. Besides, its high-pitched sound regeneration characteristic is higher and its power consumption is smaller. Hence, it is suitable for portable equipment. It also has advantages in that a hands-free can be realized without blocking the air pathway of an ear, a voice can be picked up even in a noisy place, and the like. In FIG. 11, an ornament portion 50 is formed by a semi-transparent member and can emit light when a cellular phone receives a signal. This enables those around a wearer to be aware of this reception by the cellular phone. Its power is supplied from a built-in battery, and an LED emits light at the time of the reception. Or, a pattern antenna and a rectifying circuit are embedded in the ornament portion 50. Then, using a radio wave of transmission and reception, it may also generate power itself so that the LED can emit light. The ornament portion 50 can be detached from a main substrate 51 and also works as a charging battery. Such a charging battery can be exchanged and such an ornament portion can be replaced with a fancier one. For example, the ornament portion 50 is designed to be screwed or fitted into, and attached to, the main substrate 51. Thereby, a user can exchange it easily. This makes it possible to change a plurality of designed ornament portions with different LED colors, various jewels and the like, by taking the time, the place and the occasion on that day into consideration. The ornament portion 50 can also be designed so as to be housed in a charger and be charged. In FIG. 12, a piezoelectric bone-conduction loudspeaker body 53 is connected, via an earlobe attachment portion 52 which has a clip function (i.e., a function of holding the auricle between), to the main substrate 51. Herein, the earlobe attachment portion 52 not only mechanically connects the piezoelectric bone-conduction loudspeaker body 53 and the main substrate 51, but also has an electrical contact and makes a wire connection.

### Practical Example 10

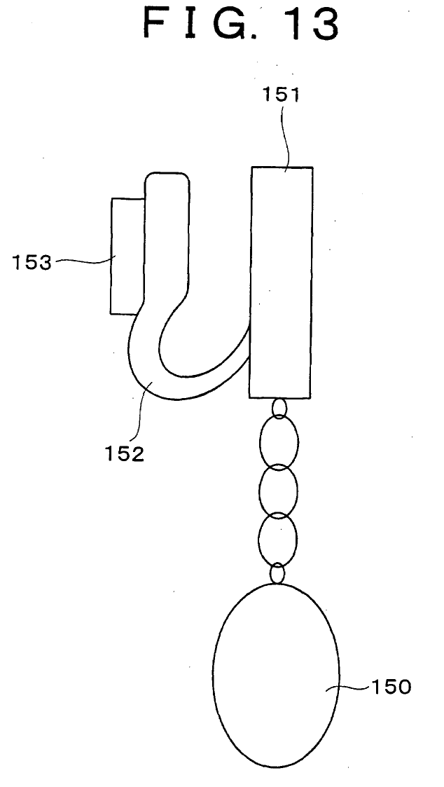

Practical Example 10 will be described with reference to FIG. 13. FIG. 13 is a side view of a bone-conduction loudspeaker microphone combined with an ear ornament (e.g., a clip-type ear ornament which holds the auricle between without making a hole piercing the auricle in the human body), showing a practical example where an ornament portion hangs from it. A charging battery (or a throwaway battery) is housed in an ornament portion 150, and the ornament portion 150 is connected via a comparatively decorative cord to a main substrate 151. Then, it is linked, via an earlobe attachment portion 152 having a necessary cable inside, to a piezoelectric bone-conduction loudspeaker body 153. Herein, the earlobe attachment portion 152 has a sufficient spring function and holds the auricle between. Simultaneously, it supports the weight of the piezoelectric bone-conduction loudspeaker body 153, the main substrate 151 and the ornament portion 150. In FIG. 13, the main substrate 151 is drawn so as to be provided on the face of an ear. However, another practical example is also thinkable in which it is united with the piezoelectric bone-conduction loudspeaker body 153.

### Practical Example 11

Practical Example 11 will be described with reference to FIG. 14. FIG. 14 is a side view of a bone-conduction loudspeaker microphone used as a pierced earring, showing a practical example where a battery, a substrate and a loudspeaker body are provided on the backside of the auricle. A hole which pierces an earlobe or an auricular cartilage 200 is made, and it is attached as a pierced earring. In this practical example, an earlobe attachment portion 252 is a pierced earring such as a metal. A battery is provided inside of a main substrate 251. In other words, an ornament portion 250 is united with the main substrate 251. In this structure, the check of the earlobe attachment portion 252 on the face side of an ear has only a mechanical-check function and needs to have an electrical contact.

### Practical Example 12

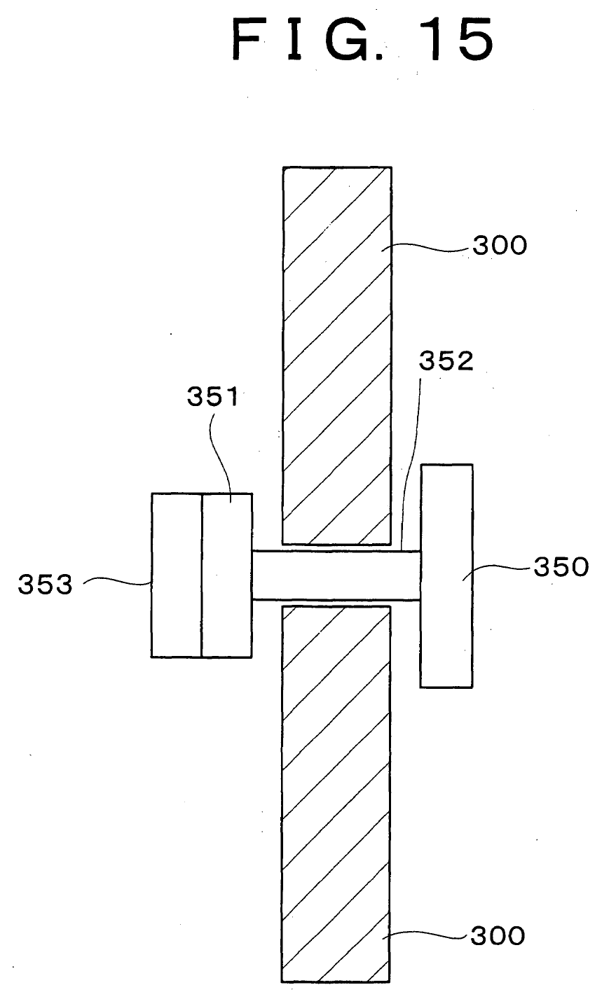

Practical Example 12 will be described with reference to FIG. 15. FIG. 15 is a side view of a bone-conduction loudspeaker microphone used as a pierced earring, showing a practical example where a battery (i.e., an ornament portion 350) is provided on the face of the auricle while a main substrate 351 and a loudspeaker body 353 are provided on its backside. Herein, a hole is made which pierces an earlobe or an auricular cartilage 300 which is a part of the auricle. The total weight of the main substrate 351 and the loudspeaker body 353 and the weight of the ornament portion 350 including the battery are designed to be in balance. An earlobe attachment portion 352 is provided with a screw which is concentric and has two electrical contacts, so that it can be detached from the ornament portion 350.

### Practical Example 13

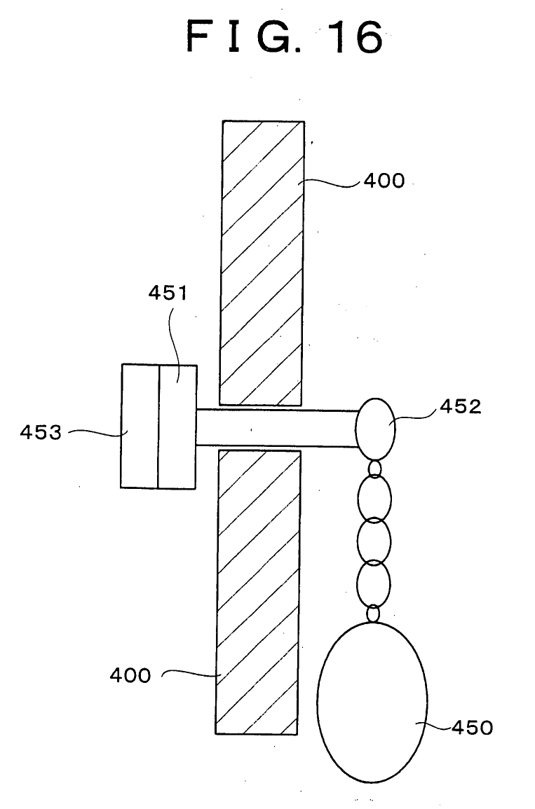

Practical Example 13 will be described with reference to FIG. 16. FIG. 16 is a side view of a bone-conduction loudspeaker microphone used as a pierced earring, showing a practical example where a battery (i.e., an ornament portion 450) hangs from an earlobe attachment portion 452 while a main substrate 451 and a loudspeaker body 453 are provided on the backside of the auricle. Herein, a hole is made which pierces an earlobe or an auricular cartilage 400 which is a part of the auricle. The total weight of the main substrate 451 and the loudspeaker body 453 and the weight of the ornament portion 450 including the battery are designed to be in balance. The earlobe attachment portion 452 can be formed as a screw which is concentric and has two electrical contacts.

Incidentally, in FIG. 14, FIG. 15 and FIG. 16, the sections of the earlobes or auricular cartilages 200, 300 and 400 are hatched.

The present invention can be applied to a variety of equipment provided with a headphone.

What is claimed is:

1. A bone-conduction loudspeaker set, comprising:
two bone-conduction loudspeaker units; and
a loudspeaker-microphone switching means which switches from a mode where the two bone-conduction loudspeaker units are used as right and left stereo loudspeakers to a mode where one of the two bone-conduction loudspeaker units is used as a loudspeaker and the other is used as a microphone, and vice versa.

2. Electronic equipment which is connected by wire or by radio to two bone-conduction loudspeaker units, comprising,
a loudspeaker-microphone switching means which: allows both of the two bone-conduction loudspeaker units to function as loudspeakers in a contents appreciation mode where a wearer of the bone-conduction loudspeaker units uses contents such as music by means of this electronic equipment; and allows one of the two bone-conduction loudspeaker units to function as a microphone in a voice input mode.

3. An electronic translation system which is connected by wire or by radio to two bone-conduction loudspeaker units, comprising,
a loudspeaker-microphone switching means which: allows both of the two bone-conduction loudspeaker units to function as loudspeakers in a contents regeneration mode where a wearer of the bone-conduction loudspeaker units uses contents such as music by means of this electronic translation system; and allows one of the two bone-conduction loudspeaker units to function as a microphone in a voice input mode where a voice given by an operator needs to be inputted.

4. An auditory support system which is connected by wire or by radio to two bone-conduction loudspeaker units, comprising,
a loudspeaker-microphone switching means which: allows both of the two bone-conduction loudspeaker units to function as loudspeakers in a contents appreciation mode where a wearer of the bone-conduction loudspeaker units uses contents such as music by means of this auditory support system; and allows one of the two bone-conduction loudspeaker units to function as a microphone in a voice input mode where a voice given by an operator needs to be inputted.

5. A navigation apparatus which is connected by wire or by radio to two bone-conduction loudspeaker units, comprising:
a loudspeaker-position detecting means which detects the positional relation between the two bone-conduction loudspeaker units; and
a map turning means which, based on a detection result obtained by the loudspeaker-position detecting means, changes the direction where a map is displayed.

6. A cellular phone which is connected by radio to two bone-conduction loudspeaker units, comprising:
a mutual-distance detecting means which detects the distance between the two bone-conduction loudspeaker units being within a predetermined distance; and
a distress-signal issuing means which issues a distress signal based on a detection result obtained by the mutual-distance detecting means.
